(19) United States
(12) Patent Application Publication
(10) Pub. No.: US 2007/0257514 A1
(43) Pub. Date: Nov. 8, 2007

(54) Windshield glass and seats arrangement for vehicle

(76) Inventor: Vladimir Smagin, Virginia Beach, VA (US)

Correspondence Address: Vladimir A. Smagin, 5717 Warning Street, Virginia Beach, VA, 23464, US

(21) Appl. No.: 11/416,308

(22) Filed: May 3, 2006

(51) Int. Cl. B62D 31/00

(52) U.S. Cl. 296/181.1

(57) ABSTRACT

An Automobile body structure includes a body (1) having a front passenger compartment (2), and a rear passenger compartment (3).

A front passenger compartment has a windshield glass (4) and the rear passenger compartment has a windshield glass (5). A front passenger compartment has a lower level floor and seats than the floor and the seats of the rear passenger compartment. The difference between the two levels is more then 200 mm.

A rear passenger compartment contains a dashboard (6) in the front of the compartment with built-in air safety bags, entertainment system, navigation system, climate control, and caps holders.

A rear passenger compartment contains a dashboard (6) in the front of the compartment with integrated personal computer with Internet access, game console, and a place for mount and connection of notebook computer.

### U.S. PATENT DOCUMENTS

| | | | |
|---|---|---|---|
| 6,793,265 B2 | September, 2004 | Kamida et al. | 296/64 |
| 4,146,263 | March, 1979 | Watari | 296/84 R |
| Re. 35,757 | March, 1998 | Heavner | 296/84.1 |
| 6,089,641 | July, 2000 | Mattarella et al | 296/64 |
| 5,833,298 | November, 1998 | Min | 296/96.13 |

### BACKGROUND OF THE INVENTION

1. Field of the Invention

The present invention relates generally to automotive vehicles. More particularly, it specifies a structure of automotive vehicle body arrangement (front and rear compartments), and windshield glass arrangement.

2. Description of the Related Art

Many arrangements for a passenger car and light truck body are known, and they generally have configuration of two or three compartments arranged one behind another. Front compartment is generally equipped with a windshield glass for forward view for driver and one or two passengers.

U.S. Pat. No. 4,146,263 issued to Watari discloses a vehicle body structure having a cowl panel assembly extending transversely between a pair of transversely spaced front pillars, said cowl panel assembly having a windshield glass support portion to which a windshield glass is adhesively attached. Described technical solution is an example of typical configuration Many arrangements for a passenger car and light truck body are known, and they generally have configuration of two or three compartments arranged one behind another. Front compartment is generally equipped with a windshield glass for forward view for driver and one or two passengers.

U.S. Pat. No. 4,146,263 issued to Watari discloses a vehicle body structure having a cowl panel assembly extending transversely between a pair of transversely spaced front pillars, said cowl panel assembly having a windshield glass support portion to which a windshield glass is adhesively attached. Described technical solution is an example of typical when front compartment passengers have a clear view through the windshield glass while rear compartment passengers have only a partial forward view, complicated by the fact that the level of the seats of the rear and the front compartments are the same.

U.S. Pat. No. 6,793,265 B2 issued to Kamida et al. discloses another passenger seat arrangement of automotive vehicle. Body of the vehicle is similar to standard configuration with the floor of the vehicle having three sections arranged one behind another rising stepwise from front to back. Due to that arrangement of seat levels visibilities of passengers are improved from that of the standard.

However, forward view for passengers of rear compartments is improved in this variant only a little since windshield glass is still positioned greater distance from the passengers of rear compartment than from the driver and the passengers in the first compartment. Also in the above configuration positioning of the additional equipment (such as air bags, entertainment system, air conditioning system, integrated personal computer with Internet access, game console, and place for mount and connection of notebook) is limited.

There are other configurations of vehicle body with different arrangement of passengers, seats and windshield; some of them are included in the reference list above, but none of the inventions and patents, taken either singly or in combination describes the instant invention as claimed.

### SUMMARY OF THE INVENTION

The present invention overcomes the disadvantages of the prior arts by providing an arrangement for second windshield glass for rear passenger compartment. Together with proposed level difference of the two compartments it allows to increase opportunities to improve the comfort and safety of the rear compartment passengers as a result of improved visibility of the road, additional console space for air safety bags, entertainment system, navigation system, climate control, caps holders, etc.

It is a principal object of the invention to provide arrangement for second windshield glass for rear passenger compartment.

Also, it is the object of the invention to provide a raised level of the rear compartment floor more them 200 mm for better positioning of the rear compartment passengers.

Another object of the invention is to provide a rear dashboard in front of the rear compartment passengers.

Another object of the invention is to provide front air bags for rear compartment passengers, mounted into the rear dashboard.

It is another object of the invention to provide arrangement of the entertainment system, navigation system, climate control, and caps holders.

It is another object of the invention to provide arrangement of the personal computer with Internet access, game console, and place for mount and connection of notebook computer.

These and other objects of the present invention will become readily apparent upon further review of the following drawings.

### DESCRIPTION OF THE DRAWINGS

FIG. 1 shows a side view of the vehicle (1). In the front compartment (2) is the position of the driver's seat and the seat of the passenger of the front compartment (7), front windshield glass (4). The seats (8) of rear compartment (3) are positioned higher than those of the front compartment by (a) more than 200 mm. The rear windshield (5) is in the rear compartment. Rear dashboard (6) for passengers of rear compartment includes built-in air safety bags, entertainment system, navigation system, climate control, personal computer with Internet access, game console, place for mount and connection of notebook computer, and caps holders.

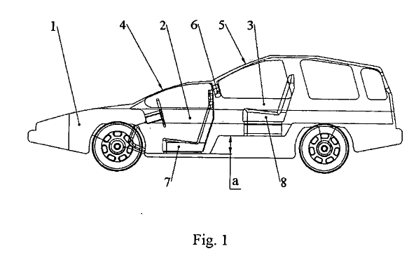

FIG. 2 shows perspective view of the vehicle. Marked on the attached drawing: front windshield (4), rear windshield (5) for passengers of rear compartment, front compartment (2), rear compartment (3); with the floor of the front compartment positioned lower than the floor of the rear compartment more than 200 mm.

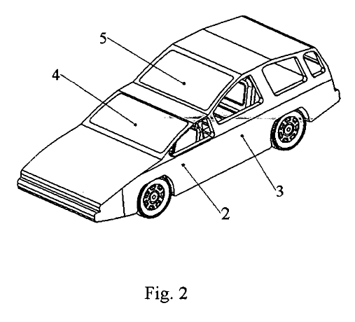

What is claimed is:

1. An automobile body structure wherein a front compartment having a windshield glass and rear passenger compartment having a separate windshield glass.

2. The vehicle of claim 1 wherein level of the rear compartment floor raised more them 200 mm.

3. The vehicle of claim 1 wherein in front of the rear passenger compartment there is dashboard with built-in air safety bags, entertainment system, navigation system, climate control, caps holders.

4. The vehicle of claim 1 wherein in front of the rear passenger compartment there is rear dashboard with integrated personal computer with Internet access, game console, and place for mount and connection of notebook computer.

5. The vehicle of claim 1 wherein front passenger compartment is divided from rear compartment with solid partition.
